(19) United States
(12) Patent Application Publication
(10) Pub. No.: US 2004/0119527 A1
(43) Pub. Date: Jun. 24, 2004

(54) Low voltage current sources/current mirrors

(76) Inventor: Radu M. Secareanu, Phoenix, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/325,180

(22) Filed: Dec. 20, 2002

(51) Int. Cl. G05F 1/10; G05F 3/02

(52) U.S. Cl. 327/538

(57) ABSTRACT

A current generator circuit and method capable of operating with a power supply voltage of less than two V_{T} utilizing a reference transistor and a buffer transistor, each transistor having a source, a drain, and a gate, the drain of the reference transistor coupled to the source of the buffer transistor, the drain of the buffer transistor adapted to be coupled to a power supply, a bias circuit coupled to the drain of the reference transistor and the source of the buffer transistor, and an amplifier coupled to the bias circuit to provide a feedback voltage substantially independent of the voltage of the power supply and sufficient to maintain the reference transistor in constant bias.

### CROSS-REFERENCES TO RELATED APPLICATIONS

1. Field of the Invention

The present invention generally relates to low voltage current sources and current mirrors, and more particularly relates to low voltage current sources and current mirrors that are highly stable under varying external loads.

2. Background of the Invention

In the past, the required power supply voltage of semiconductor circuits dropped constantly as semiconductor technology progressed. This power supply reduction has been required for fundamental device and technology reasons, as well as for higher level circuit and system requirements. The drop in the required power supply voltage for analog circuits has lagged the drop in the power supply voltage for digital circuits, and solutions have been sought to fill this gap between the two categories of circuits to make both analog and digital circuits operate at a similar power supply, particularly in those cases where both analog and digital circuits are present on the same semiconductor integrated circuit.

Future generation technologies and applications raise complex challenges for a further reduction in the power supply voltage. The requirements with respect to fundamental device physics on one hand, and fundamental circuit and system restrictions on the other hand, oppose each other when the ultimate possible limits for power supply voltage reduction for next generation technologies are pursued. The principal reason that generates this contradiction is that this evaluation is made with reference to the present state of the art. In addition, system-on-a-chip (SOC) total integration circuitry generates additional challenges in achieving the power supply voltage reduction goals for the next generation technologies and applications. According to SOC requirements, analog, RF, digital, and memory blocks must all coexist on-chip while operating at the same power supply voltage and interacting minimally (such as generating minimal noise and being highly immune to the received noise). To overcome these challenges, novel devices and/or a novel circuit/system design approach must be developed.

### BRIEF DESCRIPTION OF THE DRAWINGS

The present invention will hereinafter be described in conjunction with the following drawing figures, wherein like numerals denote like elements, and

FIG. 1 is a prior art current mirror/current source circuit;

FIG. 2 is another prior art current mirror/current source circuit;

FIG. 3 is a current mirror/current source circuit in accordance with the instant invention;

FIG. 4 is a current mirror/current source circuit in accordance with an alternative embodiment of the instant invention;

FIG. 5 is a current mirror/current source circuit in accordance with an alternative embodiment of the instant invention;

FIG. 6 is a current mirror/current source circuit in accordance with an alternative embodiment of the instant invention;

FIG. 7 is a current mirror/current source circuit in accordance with an alternative embodiment of the instant invention;

FIG. 8 is a current mirror/current source circuit in accordance with an alternative embodiment of the instant invention;

FIG. 9 is a current mirror/current source circuit in accordance with an alternative embodiment of the instant invention;

FIG. 10 is a current mirror/current source circuit in accordance with an alternative embodiment of the instant invention; and

FIG. 11 is a current mirror/current source with a self-correcting feedback control loop.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Specifically, the present invention provides current sources/current mirrors (or more generically, current sources) of different accuracies that operate at low power supply voltages with large output voltage swings. Therefore, highly constant currents are obtained when the necessary voltage “head-room” is reduced to minimum. By head-room is meant that voltage necessary to operate a circuit above the required signal level. That is, if a power supply of two volts is available, and an output signal swing of 1.4 volts is required, the power supply voltage remaining to operate the circuit itself, including necessary transistor voltage drops, is only 0.6 volts. Thus, in the absence of an output voltage, the entire circuit must be capable of operating with only 0.6 volts, the 0.6 volts being therefore the bias head-room.

This fundamental circuit requirement is the basis of the novel current mode circuit design approach of the instant invention. Based on this novel circuit design approach, novel analog/RF circuits operating at low power supply with high performances are possible. In addition, by using the present invention in well established circuits that are presently in use, the power supply requirement is greatly reduced while the performances of the circuits are substantially improved. Through the use of the methods and apparatus of the instant invention it is possible to design analog/RF circuits operating at a power supply between 1.5V_{T} and 3V_{T} with high overall performances (where V_{T} is a transistor threshold voltage drop).

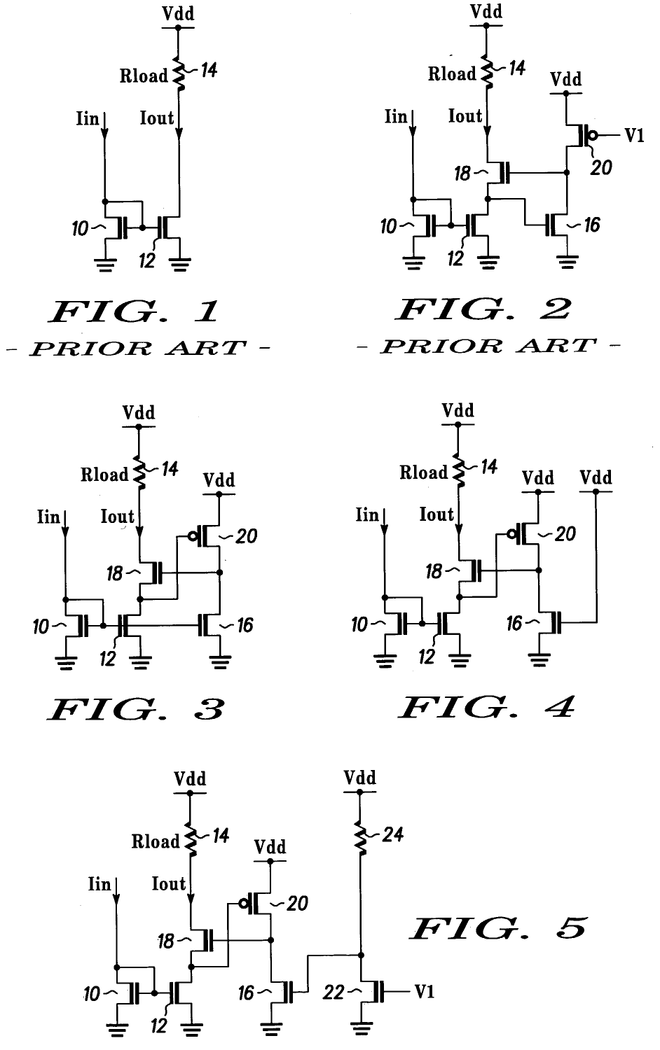

A simple current source/current mirror is shown in FIG. 1. An input current is applied to the drain of a first transistor 10. The gate of transistor 10 is coupled to its drain as well. A second transistor 12 has its gate coupled to the gate of transistor 10 and its drain coupled through a load resistance 14 to a source of power V_{dd}. Note that Iₒᵤₜ is defined by the following equation:

$${I}_{DS} = \frac{{μ}_{N} {C}_{ox}}{2} - \frac{W}{L} {( {V}_{GS} - {V}_{T} )}^{2} ( 1 + λ {V}_{DS} )$$

where I_{DS} is Iₒᵤₜ, μ is the mobility of electrons, Cₒₓ is oxide capacitance, W and L are the width and length of the transistor channel, V_{GS} is the gate to source voltage drop, VT is the transistor threshold voltage, λ is the channel length modulator and V_{DS} is the drain-source voltage drop. All the variables refer to transistor 12 of FIG. 1.

Particularly for low voltage applications where (V_{GS}−V_{T}) in the above equation is reduced and the allowable V_{DS} that maintains the transistors in saturation is limited, I_{DS} is subject to large variations.

To reduce the I_{DS} variations with V_{DS}, the circuit shown in FIG. 2 provides active feedback. As compared to the circuit shown in FIG. 1, transistor 16 is added to maintain a constant V_{DS} at the drain of transistor 12 (and source of transistor 18), with the load variation, noise, and power supply variation, therefore achieving the goal of maintaining a constant output current Iₒᵤₜ. Transistor 18 provides the current mode output and, together with transistors 16 and 20 constitutes an active feedback amplifier.

Note that the operation of the current source/current mirror shown in FIG. 2 is limited only to circuits using a large power supply, first, because the V_{DS} of transistor 10 can not be decreased below 1V_{T} and second because an output voltage swing for the current mirror has to be provided. Typical operation of this circuit is for a power supply voltage V_{DD} greater than 6V_{T}. For example, with a V_{DD} of 2.0 volts, the V_{SD} of transistor 12 may be 0.6V and of transistor 18, 0.2V. Those drops leave only 1.2V of signal swing. To obtain a usable voltage swing of 1.8V or more, a V_{DD} of 2.6V or more is needed.

The circuit shown in FIG. 3 is a basic current source/current mirror according to the present invention. This circuit is designed to operate with a power supply as low as 1.25V_{T}. The p-channel transistor 20 has its gate coupled between the source of transistor 18 and the drain of transistor 12, and the gate of transistor 16 is coupled to the gate of transistor 12. Coupling the gate of transistor 20, which is a biasing transistor, to the node between transistors 12 and 18 maintains the node at a relatively constant voltage. The V_{DS} of transistor 12 is designed so that transistor 12 is maintained in saturation at all times, or, V_{DS}>V_{GS}−V_{T}.

Note that, for example, if, for transistor 12, V_{GS}=0.5 volts and V_{T}=0.4 volts, V_{DS} at the drain of transistor 12 can be as low as 0.1 volt. This bias situation provides a high voltage swing for the output while operating at low power supply voltages, while at the same time insuring high accuracy and a constant output current. For example, if V_{DD} is 0.8V, and the V_{DS} of transistors 12 and 18 are each 0.1V, that leaves 0.6V for signal voltage across the load 14. Transistors 16, 18, and 20 maintain a constant V_{DS} for transistor 12 independent of load variations, noise, or power supply variations. However, the sensitivity of the output current to power supply variations for the circuit shown in FIG. 3 is important since a power supply variation is reflected directly into the V_{DS} of transistor 12 through the V_{GS} of transistor 20, being only reduced by the gain of transistor 20.

The power supply rejection ratio (PSSR) of the circuit of FIG. 3 can be improved if transistor 16 is biased as shown in FIG. 4. The circuit of FIG. 4 introduces a feedback that monitors and compensates for power supply variations. Instead of taking a bias voltage from transistor 20 as shown in FIG. 3, the gate of transistor 16 is coupled directly to V_{DD}. The voltage variation at the node between the source of transistor 18 and drain of transistor 12 is therefore synchronized with V_{DD} variations.

The feedback introduced for the circuit shown in FIG. 4 may be further improved by the circuit shown in FIG. 5. Transistor 22, together with the resistor 24, introduces the right amount of feedback so that theoretically the output current variations generated by the power supply variations can be reduced to zero. In FIG. 4 the gain is produced by transistor 16 alone. In the circuit of FIG. 5, transistor 22 and resistor 24 contribute as well. The use of resistor 24 to provide the right amount of feedback is required due to the reduced power supply. However, incorporating resistors typically requires a more expensive technology, therefore, a solution to eliminate the use of resistors is preferred.

Such a circuit is described in FIG. 6. The resistor 24 from FIG. 5 can be replaced by transistor 26, as shown in FIG. 6. This however requires a power supply of between 2V_{T} and 3V_{T}, since an additional V_{GS} drop is incurred by transistor 26.

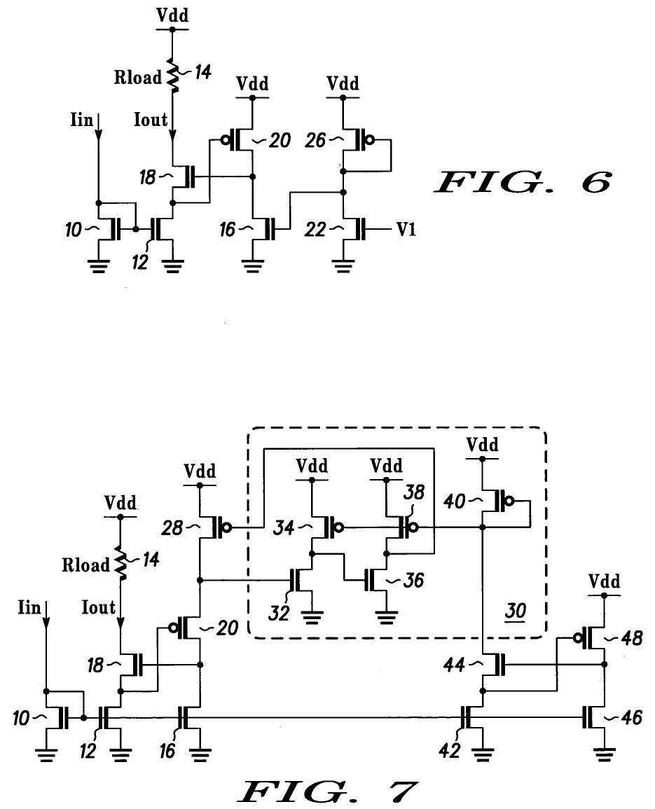

The circuit shown in FIG. 7 is designed to operate with a power supply as low as 1.4V_{T}. The major improvement in this circuit over that of FIG. 3 is brought about by the introduction of transistor 28, which may be referred to as a spring transistor, and an amplifier 30. The goal of the spring transistor 28 is to reduce power supply variations by tracking V_{DD} and in conjunction with amplifier 30, creating a virtual V_{DD} at the node between the drain of transistor 28 and the source of transistor 20. The amplifier 30 consists of transistors 32, 34, 36, 38, and 40.

The amplifier 30, for accuracy and power supply compatibility reasons, is biased by a current source comprising transistors 42, 44, 46, and 48 in a configuration similar to that of the biasing circuit of FIG. 3, which biases transistor 40. Note that the amplifier 30 provides control for, and regulates the operating point of transistor 28, since it is placed in a feedback loop with respect to transistor 28. In other words, the goal of the amplifier is to provide a constant V_{GS} for transistor 32, a V_{GS} that is intended to be highly insensitive to power supply variations and noise. The magnitude of this V_{GS} is of great importance for low power supply operation. The V_{GS} of transistor 32 must be designed such that for the estimated power supply variations, the voltage in the source of transistor 20 does not go below the nominal voltage that is required to maintain transistor 12 in saturation and provide the required accuracy for the output current, while, for the entire range of power supply variation, transistor 28 is maintained in saturation or at the limit between saturation and linear. The latter condition is imposed in order to minimize the voltage swing in the drain of transistor 36 with the power supply variations, and therefore minimize the V_{GS} variations of transistor 32 with the power supply variations.

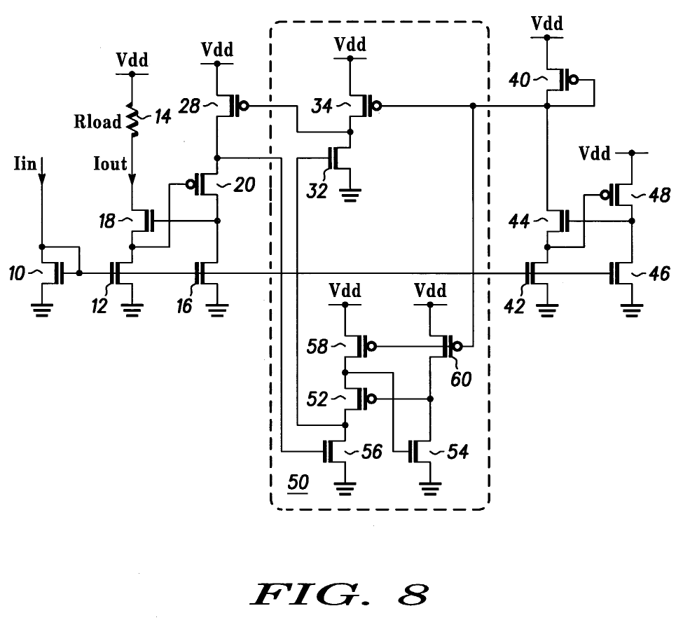

The power supply rejection ratio of the circuit shown in FIG. 7 may be further improved by the circuit shown in FIG. 8 by increasing the gain of the amplifier that controls and regulates the operating point of transistor 28. Note that the amplifier 50 consists now of transistors 32, 34, 52, 54, 56, 58, and 60. The latter five transistors represent a current source similar to the circuit shown in FIG. 3, where transistor 56 is the load. The constancy of the virtual power supply in the source of transistor 20 is thus further improved. The biasing circuit comprising transistors 40, 42, 44, 46, and 48 is similar to the circuit with like components in FIG. 7.

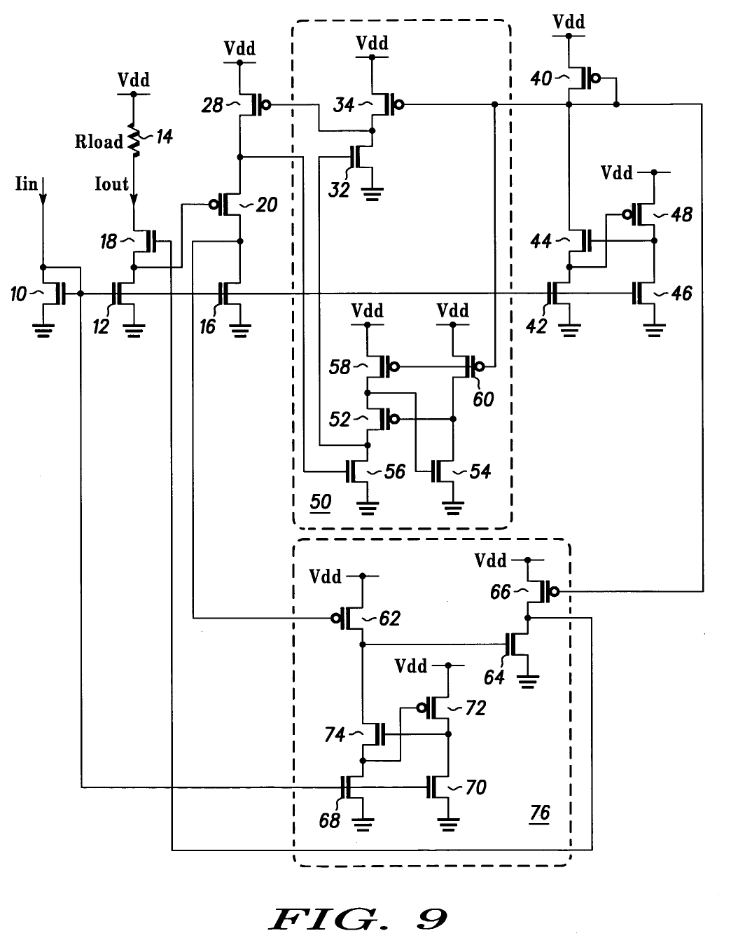

Note that with any of the disclosed circuits, transistor 20 can never be biased to operate in the saturation region. In the best case, transistor 20 can operate on the boundary between the saturation and linear regions. While transistor 20 is typically linear, any IDS and V_{DS} variations for transistor 20 have a larger impact on the V_{DS} of transistor 12 and ultimately on the output current, than if when transistor 20 is saturated. A solution to this problem is provided according to the circuit shown in FIG. 9. Transistor 62 provides the appropriate highly constant bias for both transistors 16 and 20.

The circuit of FIG. 9 addresses the load variations through a feedback amplifier consisting of transistors 12, 16, 18, and 20. The gain of this amplifier, while sufficient for many applications, is limited. The circuit shown in FIG. 9 increases this gain, which provides high accuracy for the output current of the current source/current mirror circuit. In between transistors 18 and 20, an additional amplifier 76 of significant gain is introduced. The amplifier consists of transistors 62, 64, 66, 68, 70, 72, and 74. The gate of transistor 18 is applied as an input to amplifier 76, which creates a voltage level (V_{GS} of transistor 62) sufficient to keep transistor 16 in saturation at all times.

While the circuit techniques of this invention can be extended to any current source/current mirror that employs active feedback independent of power supply, operation at low power supply voltages creates additional constraints. For example, the circuit shown in FIG. 10 represents a current source/current mirror that operates at large power supplies (larger than 2V_{T}) while providing high accuracy for a high output voltage swing. The circuit is similar to that of FIG. 7 except that, in order to permit high-voltage operation, transistor 40 is biased with a current source according to FIG. 2 instead of a current source according to FIG. 3.

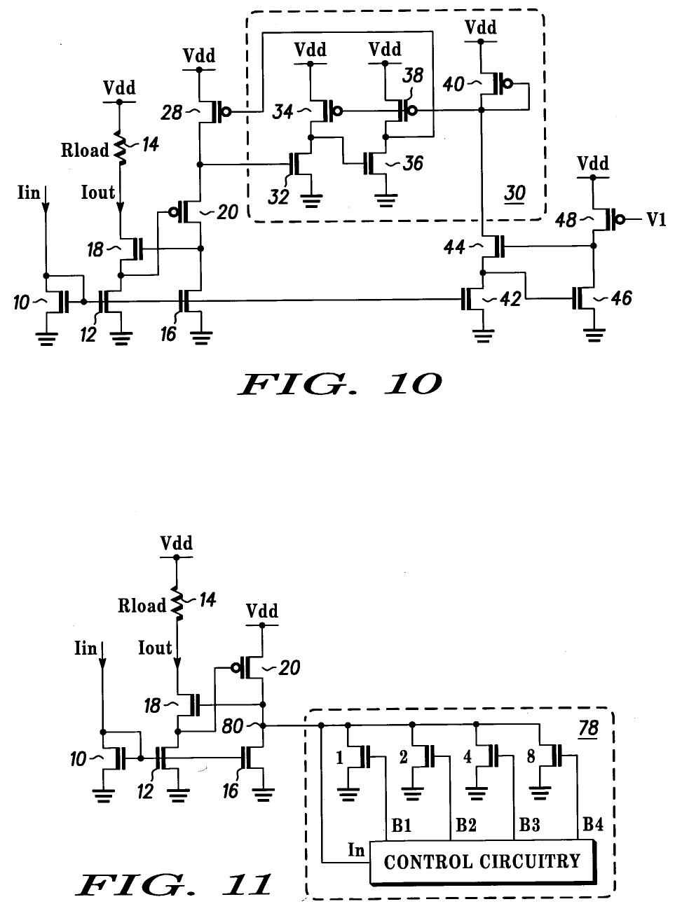

Any of the above circuits according to the present invention provide the possibility of self-correcting the accuracy of the output current. This is a highly useful capability especially at such low power supplies where on-chip noise may induce large errors. The self correcting facility is also useful in pulling the output current to a specific desired value, therefore compensating for process parameter variations and matching errors. The principle of this self-correcting technique is shown in FIG. 11 taken in conjunction with the circuit of FIG. 3. A feedback control loop 78 is placed between an input node 80 that is monitored and an output node that contributes to keeping the circuit in a desired state. The optimal input and output nodes for the feedback control loop in this particular case coincide. However, for different implementations according to the present invention, the optimal input and output nodes for the feedback control loop may be different. The control circuitry may contain a programmable comparator. For steady-state nominal operation, the output of the comparator controls the output node of the feedback loop to bias transistor 20 so that the desired output current is generated at the output of the current mirror/current source, Iₒᵤₜ. Any perturbation on the input node of the feedback loop modifies the output of the comparator, which modifies the bias point of transistor 20 which maintains the output current Iₒᵤₜ to the desired value. Note also that this technique may provide similar accuracy for a simpler circuit (such as shown in FIG. 3) implementing this technique with a more complex circuit (such as shown in FIG. 9) that does not implement this technique.

While several exemplary embodiments have been presented in the foregoing detailed description of the invention, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A current generator circuit capable of operating with a power supply voltage of approximately between one and two V_{T} comprising:
a first reference transistor, a second reference transistor, a buffer transistor and a bias transistor, each transistor having a source, a drain, and a gate;
the gate of the bias transistor is coupled to the drain of the first reference transistor and the source of the buffer transistor;
the gate of the buffer transistor is coupled to the drain of the second reference transistor and the drain of the bias transistor;
the gates of the first reference transistor and the second reference transistor adapted to be coupled to a reference voltage;
and the drain of the buffer transistor is adapted to be coupled to a load;
whereby the voltage at the drain of the first reference transistor is maintained substantially constant.

2. A current generating circuit as set forth in claim 1 wherein the gate of the second reference transistor is adapted to be connected to the power supply voltage.

3. A current generating circuit as set forth in claim 1 wherein the first reference transistor and the second reference transistor are of a first polarity and the bias transistor is of the opposite polarity.

4. A current generating circuit as set forth in claim 1 wherein the gate of the second reference transistor is coupled to a biasing circuit having at least an additional transistor for providing additional gain to contribute to maintaining the voltage at the drain of the first reference transistor substantially constant.

5. A current generating circuit as set forth in claim 4 wherein the biasing circuit further comprises a second transistor having a drain coupled to the drain of the additional transistor, and having a source adapted to be coupled to the power supply.

6. A current generating circuit as set forth in claim 4 wherein the biasing circuit provides feedback to the drain of the first reference transistor to reduce the dependence of the voltage at the drain of the first reference transistor on the power supply voltage.

7. A current generating circuit as set forth in claim 6 wherein the biasing circuit further comprises a second transistor having a drain coupled to the drain of the additional transistor, and having a source adapted to be coupled to the power supply.

8. A current generator circuit capable of operating with a power supply voltage of less than two V_{T} comprising:
a first reference transistor, a second reference transistor, a buffer transistor and a bias transistor, each transistor having a source, a drain, and a gate;
the gate of the bias transistor is coupled to the drain of the first reference transistor and the source of the buffer transistor;
the gate of the buffer transistor is coupled to the drain of the second reference transistor and the drain of the bias transistor;
the gates of the first reference transistor and the second reference transistor adapted to be coupled to a reference voltage;
the drain of the buffer transistor is adapted to be coupled to a load;
a spring transistor having a source, drain, and gate, the drain coupled to the drain of the buffer transistor and a source adapted to be coupled to a power supply;
the gate of the spring transistor providing an input to a feedback amplifier, the output of the feedback amplifier being coupled to the drain of the spring transistor; and
whereby a voltage is established at the drain of the spring transistor that is substantially independent of voltage variations in the power supply.

9. A current generating circuit as set forth in claim 8 wherein the gate of the second reference transistor is coupled to a biasing circuit having at least an additional transistor for providing additional gain to contribute to maintaining the voltage at the drain of the first reference transistor substantially constant.

10. A current generating circuit as set forth in claim 8 wherein the voltage at the drain of the first reference transistor is maintained substantially constant with respect to variations in power supply voltage and load.

11. A current generating circuit as set forth in claim 10 wherein the gate of the second reference transistor is adapted to be connected to the power supply voltage.

12. A current generating circuit as set forth in claim 10 further comprising a second amplifier having an input and an output, the output of the second amplifier being coupled to the gate of the buffer transistor and the input of the second amplifier being coupled to the drain of the second reference transistor.

13. A current generator circuit capable of operating with a power supply voltage of less than two V_{T} comprising:
a reference transistor and a buffer transistor, each transistor having a source, a drain, and a gate;
the drain of the reference transistor coupled to the source of the buffer transistor, the drain of the buffer transistor adapted to be coupled to a power supply;
a bias circuit coupled to the drain of the reference transistor and the source of the buffer transistor; and
an amplifier coupled to the bias circuit to provide a feedback voltage substantially independent of the voltage of the power supply and sufficient to maintain the reference transistor in constant bias.

14. A current generator circuit as set forth in claim 13 further comprising a spring transistor having a source, a drain, and a gate, the gate of the spring transistor providing an output to the amplifier, an input of the amplifier being coupled to the drain of the spring transistor, whereby a voltage is established at the drain of the spring transistor that is independent of voltage variations in the power supply.

15. A current generating circuit as set forth in claim 14 wherein the voltage at the drain of the reference transistor is maintained substantially constant with respect to variations in power supply voltage and load.

16. A method for providing a current generating circuit capable of operating at less than 2V_{T}, comprising:
providing a current mirror circuit adapted to be coupled to a source of power and having a reference transistor;
providing a bias circuit coupled to the current mirror circuit for biasing the current reference transistor;
providing an active device as a part of the bias circuit, coupling across the active device an amplifier for sensing voltage variations in the power supply and feeding back to the bias circuit a signal representative of the voltage variation in the power supply; and
whereby the bias circuit adjusts the bias on the reference transistor to maintain the reference transistor in constant bias.

17. A current generator circuit capable of operating with a power supply voltage of greater than two V_{T} comprising:
a first reference transistor, a second reference transistor, a buffer transistor and a bias transistor, each transistor having a source, a drain, and a gate;
the gate of the bias transistor is coupled to the drain of the first reference transistor and the source of the buffer transistor;
the gate of the buffer transistor is coupled to the drain of the second reference transistor and the drain of the bias transistor;
the gates of the first reference transistor and the second reference transistor adapted to be coupled to a reference voltage;
the drain of the buffer transistor is adapted to be coupled to a load;
a spring transistor having a source, drain, and gate, the drain coupled to the drain of the buffer transistor and a source adapted to be coupled to a power supply;
the gate of the spring transistor providing an input to a feedback amplifier, the output of the feedback amplifier being coupled to the drain of the spring transistor; and
whereby a voltage is established at the drain of the spring transistor that is independent of voltage variations in the power supply, and the first reference transistor is biased to maintain a voltage from drain to source that is substantially constant with respect to variations in power supply voltage and load to allow a signal voltage swing greater than V_{T}.

18. A current generator circuit capable of operating with a power supply voltage of less than two V_{T} and producing an output current, comprising:
a reference transistor and a buffer transistor, each transistor having a source, a drain, and a gate;
the drain of the reference transistor coupled to the source of the buffer transistor;
the drain of the buffer transistor adapted to be coupled to a power supply;
a bias circuit coupled to the drain of the reference transistor and the source of the buffer transistor; and
a self-correcting feedback loop coupled to the bias circuit to provide a feedback voltage to the bias circuit such that any perturbation on the input node of the feedback loop modifies the bias point of the bias transistor which maintains the output current of the current generator circuit to the desired value.
